(19) United States
(12) Patent Application Publication
(10) Pub. No.: US 2025/0283782 A1
(43) Pub. Date: Sep. 11, 2025

(54) Light Generator

(71) Applicant: Cox Communications, Inc., Atlanta, GA (US)

(72) Inventor: Matthew Paul Hicks, Atlanta, GA (US)

(21) Appl. No.: 18/599,847

(22) Filed: Mar. 8, 2024

(51) Int. Cl. G01M 11/00; G02B 6/255; H04B 10/073

(52) U.S. Cl. CPC G01M 11/332; H04B 10/0731; G02B 6/255

(57) ABSTRACT

An example test system for fiber optic cable installation includes a light receiver configured to be deployed on a distal end of a fiber optic cable; a field light generator configured to be deployed on a proximal end of the fiber optic cable, the field light generator comprising: a power supply; an optical fiber assembly configured to couple to the proximal end of the fiber optic cable; and a light source operably coupled to the power supply, where the light source is configured to output light through the optical fiber assembly into the proximal end of the fiber optic cable.

### BACKGROUND

Optical fibers are transparent fibers that transmit light from one end of the fibers to another end of the fibers. Optical fibers can transmit data over long distances without electromagnetic interference. Additionally, optical fibers have lower signal losses when compared to similar metal wires. Therefore, optical fibers are commonly used for high bandwidth communications across long distances.

Installation of communication systems including optical fibers can involve splicing sections of optical fiber optic cable together to form longer sections of optical fiber. Splices can introduce losses to the communication system where some light is lost in the splice. Installation of optical fibers can include checking the splices to detect faults in the splice that would cause excessive losses in the communication system.

There are benefits to improving methods and systems for installing and testing fiber optic cables.

### SUMMARY

In some aspects, the implementations described herein relate to a test system for fiber optic cable installation, the test system including: a light receiver configured to be deployed on a distal end of a fiber optic cable; a field light generator configured to be deployed on a proximal end of the fiber optic cable, the field light generator including: a power supply; an optical fiber assembly configured to couple to the proximal end of the fiber optic cable; and a light source operably coupled to the power supply, wherein the light source is configured to output light through the optical fiber assembly into the proximal end of the fiber optic cable.

In some aspects, the implementations described herein relate to a test system, wherein the test system further includes a waterproof case configured to house the field light generator.

In some aspects, the implementations described herein relate to a test system, wherein the optical assembly includes an active optical splitter operably coupled between the light source and the proximal end of the fiber optic cable.

In some aspects, the implementations described herein relate to a test system, wherein the field light generator further includes a controller operably coupled to the power supply and the light source.

In some aspects, the implementations described herein relate to a test system, wherein the controller further includes a wireless receiver configured to receive a control signal and wherein the controller is configured to energize or de-energize the light source based on the control signal.

In some aspects, the implementations described herein relate to a test system, wherein the optical assembly includes a multi-port optical splitter.

In some aspects, the implementations described herein relate to a test system, wherein the light receiver is configured to measure an intensity of light at the distal end of the fiber optic cable.

In some aspects, the implementations described herein relate to a test system, wherein the optical assembly includes an active splitter operably coupled to the power supply.

In some aspects, the implementations described herein relate to a test system, wherein the light source includes a small form pluggable (SFP) connector, and an SFP transceiver.

In some aspects, the implementations described herein relate to a test system, wherein the power supply includes at least one of a solar panel and a battery.

In some aspects, the implementations described herein relate to a test system, wherein the fiber optic cable includes a first fiber of fiber optic cable and a second fiber of fiber optic cable.

In some aspects, the implementations described herein relate to a field light generator including: a power supply including a battery and power regulation circuitry; an optical assembly configured to couple to a proximal end of a fiber optic cable; and a light source operably coupled to the power supply, wherein the light source is configured to output light through the optical assembly into the proximal end of the fiber optic cable.

In some aspects, the implementations described herein relate to a field light generator, further including a waterproof case configured to encapsulate the power supply, optical assembly, and light source.

In some aspects, the implementations described herein relate to a field light generator, wherein the optical assembly includes an active optical splitter operably coupled between the light source and the proximal end of the fiber optic cable.

In some aspects, the implementations described herein relate to a field light generator, wherein the optical assembly includes a passive optical splitter operably coupled between the light source and the proximal end of the fiber optic cable.

In some aspects, the implementations described herein relate to a field light generator, wherein the field light generator further includes a controller operably coupled to the power supply and the light source.

In some aspects, the implementations described herein relate to a field light generator, wherein the controller further includes a wireless receiver configured to receive a control signal and wherein the controller is configured to enable or disable the light source based on the control signal.

In some aspects, the implementations described herein relate to a field light generator, wherein the optical assembly includes a multi-port optical splitter.

In some aspects, the implementations described herein relate to a field light generator, wherein the light source includes a frequency selectable light source operably coupled to the controller and wherein the controller can select the frequency of the light output from the light source.

In some aspects, the implementations described herein relate to a method of validating a fiber optic installation without a field router, the method including: laying a first section of fiber optic cable, the first section of fiber optic cable having a proximal end and a distal end; attaching a field light generator to the proximal end of the first section of fiber optic cable; laying a second section of fiber optic cable, the second section of fiber optic cable having a proximal end and a distal end; splicing the proximal end of the second section of fiber optic cable to the distal end of the first section of fiber optic cable; attaching a fiber optic receiver to the distal end of the second section of fiber optic cable; and detecting, based on a light signal received at the fiber optic receiver and a light output by the field fiber optic generator, a fault in the splice between the first section of fiber optic cable and the second section of fiber optic cable.

### BRIEF DESCRIPTION OF DRAWINGS

FIG. 1 illustrates an example field light generator, fiber optic cable, and light receiver, according to implementations of the present disclosure.

FIG. 2 illustrates an example field light generator including a splitter, multiple fiber optic cables, and a light receiver, according to implementations of the present disclosure.

FIG. 3 illustrates a field light generator, a light receiver, and a first and second fiber optic cable, according to implementations of the present disclosure.

FIG. 4A illustrates a field light generator including a case and a solar panel, according to implementations of the present disclosure.

FIG. 4B illustrates a field light including a case and a solar panel, according to implementations of the present disclosure.

FIG. 5 illustrates an example method for validating a fiber optic installation without a field router, according to implementations of the present disclosure.

FIG. 6 illustrates an example computing device.

### DETAILED DESCRIPTION

Communication systems often include fiber optic cables. Fiber optic cables can be coupled between network equipment (e.g., transmitters, receivers, transceivers, field routers, etc.) to transmit data through the communication system. Fiber optic cables are often installed by placing multiple sections of fiber optic cables that that are coupled together (e.g., spliced) into a longer fiber optic cable during installation.

Because fiber optic cables operate by transmitting light between two points (e.g., a transmitter to a receiver), the fiber optic cable's performance is tested using light. If the fiber optic cable is tested when the communication system is completed, then installation defects like faults in fiber optic cable splices may only be detected at the end of an installation project, when the difficulty in repairing or replacing splices can be greatest. Therefore, there are benefits to testing fiber optic cable splices and other parts of the communication system intermittently as the system is installed.

For example, implementations of the present disclosure include field light generators that can be temporarily connected to a fiber optic cable to illuminate the fiber optic cable during the installation process. For example, the fiber optic cable can be illuminated as additional fiber optic cables are spliced. The field light generator can also be used to validate couplings between the fiber optic cable and other parts of the communication system (e.g., receivers or transceivers). Additionally, implementations of the present disclosure include systems for using field light generators to test fiber optic splices during installation, and methods of installing fiber optic cables including testing during the installation. The field light generators described herein can be portable, which can allow the field light generators to be moved to different fiber optic cables to test different parts of a fiber optic communication system as the fiber optic communication system is being installed.

Implementations of the present disclosure allow for a “multistage” method of installing fiber optic cables. A field light generator as described herein can be used to supply a portable ruggedized light generator to one end of a fiber optic cable. When the field light generator is deployed, a team of fiber optic installers can use a receiver coupled to the opposite end of the fiber optic cable at any time in the installation process to validate that light is passing through the fiber optic cable and to verify that the amount of light is within an expected range. If the amount of light is not within the expected range, then the installers can determine that a fault exists in a splice or other part of the fiber optic cable, and repair the fault before the installation is completed.

Implementations of the present disclosure include systems for providing light sources to fiber optic cables during the installation of fiber optic cables. This allows for the fiber optic cable to be tested during each step of the installation.

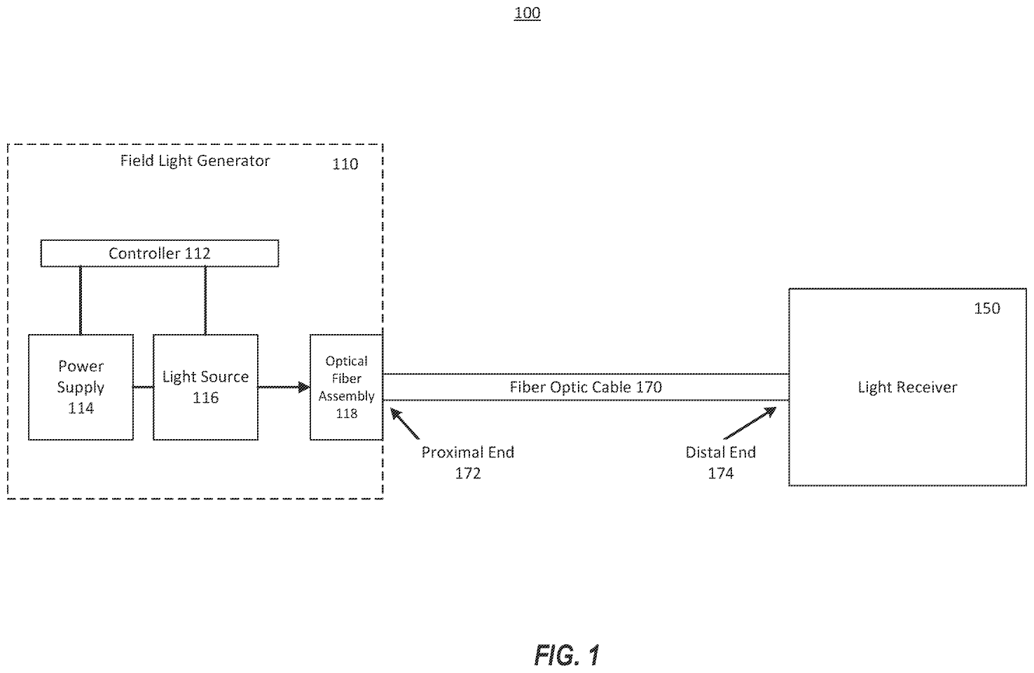

With reference to FIG. 1, an example system 100 is shown according to implementations of the present disclosure. The system includes a field light generator 110 and a light receiver 150. The field light generator 110 is coupled to a proximal end 172 of the fiber optic cable 170 and the light receiver 150 is coupled to the distal end 174 of the fiber optic cable 170. The light receiver 150 can be configured to measure an intensity of light at the distal end 174 of the fiber optic cable 170. The light receiver 150 can include a photodiode or photodetector which are semiconductor devices configured to generate an electrical current and/or voltage in response to receiving photons (light). The light receiver 150 can also include a phototransistor, which is a transistor where electrons are injected into the base of the transistor in response to receiving photons.

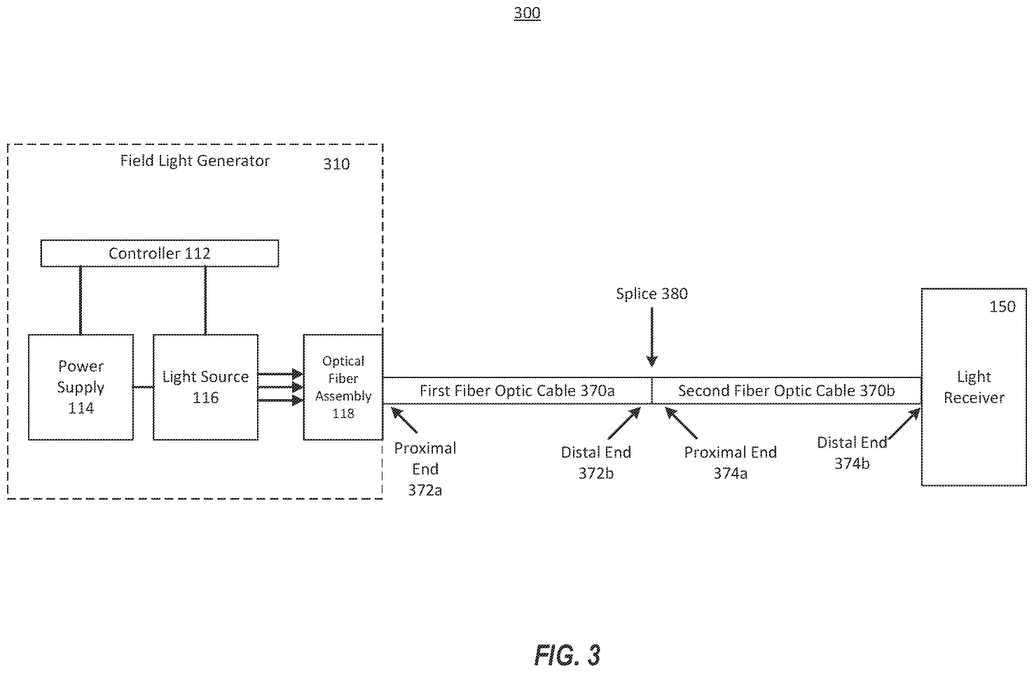

The fiber optic cables described herein (e.g., the fiber optic cable 170 shown in FIG. 1) can include any number of optical fibers in parallel, as well as any number of optical fibers spliced end-to-end (e.g., a plurality of fiber optic cables as shown in FIG. 3).

The field light generator 110 includes a light source 116. The light source 116 can be configured to illuminate the proximal end 172 of the fiber optic cable 170. The light source 116 can be any light source configured to illuminate one or more optical fibers. For example, the light source 116 can include a light emission element, a small form pluggable (SFP) connector, and an SFP and an SFP transceiver. Examples of light emission elements that can be used for the light source 116 include LED's and laser diodes, but it should be understood that any light emission element can be used, including lamps and bulbs (e.g., halogen or xenon lamps). Light source 116 may have a single output operably connected to the optical fiber assembly 118 or more than one output.

In some implementations, the light source 116 is a frequency selectable light source. Optionally, the light source 116 can be configured to emit a specific wavelength of light.

Communication systems that use fiber optic cables can be configured for different wavelengths of light. Example wavelengths of light commonly used in fiber optic communication systems include approximately 850 nm, approximately 1300 nm, and approximately 1500 nanometers. Implementations of the present disclosure include light sources 116 configured to emit these wavelengths, as well as any other wavelength of light.

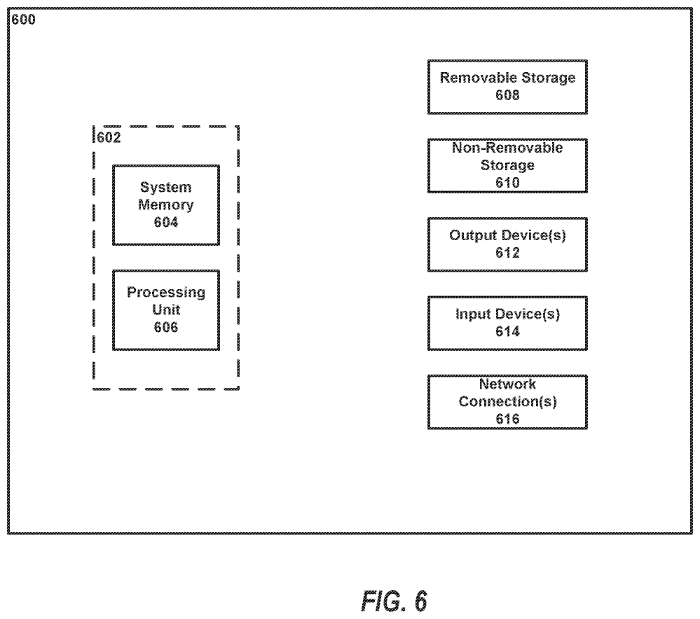

Still with reference to FIG. 1, the field light generator 110 can optionally include a controller 112. The controller 112 can be operably coupled to the power supply 114, for example using one or more communication links. This disclosure contemplates that the communication links are any suitable communication link. For example, a communication link may be implemented by any medium that facilitates data exchange including, but not limited to, wired, wireless and optical links. The controller 112 can include a computing device (e.g., any or all of the components of the computing device 600 shown in FIG. 6).

The controller 112 can optionally be configured to control the light source 116. For example, the controller 112 can be configured to control the power supply 114 in order to energize/deenergize the light source 116.

Alternatively, or additionally, the controller 112 can be operably coupled to the light source 116, for example using one or more communication links. Again, this disclosure contemplates that the communication links are any suitable communication link. For example, a communication link may be implemented by any medium that facilitates data exchange including, but not limited to, wired, wireless and optical links. Optionally, the controller 112 can be configured to control the light source 116 in order to energize and/or deenergize the light source 116. Similarly, the controller 112 can be configured to change the wavelength of the light source 116 in implementations where the light source is a frequency selectable light source. As a non-limiting example, if the frequency selectable light source can transmit 850 nm, 1300 nm, and 1500 nm wavelengths of light, the controller 112 can be configured to cycle between those wavelengths (e.g., in response to user inputs), for example by adjusting characteristics of control and/or power signals.

Optionally, the controller 112 can be coupled to a mobile computing device (not shown) through a network. For example, in some implementations the controller 112 can include the network connections 616 described with reference to FIG. 6. The network connections 616 can include Wi-Fi, Bluetooth, cellular data, and/or any other wireless network connections to enable remote control of the controller 112 by a remote mobile computing device. The controller 112 can be configured to control the light source 116 based on inputs from the mobile computing device (e.g., changing the wavelength of the light source or energizing/deenergizing the light source).

Optionally, the light source 116 can be coupled to the fiber optic cable 170 through a fiber optic assembly 118. Non-limiting examples of fiber optic assemblies that can be used as the fiber optic assembly 118 include optical fibers, fiber optic cable connectors, optical splitters, multi-port optical splitters, active optical splitters, and multi-port active optical splitters. It should be understood that the fiber optic assembly 118 can include any number and combination of fiber optic assembly 118 can include any number of optical fibers, fiber optic cable connectors, optical filters, optical splitters, multi-port optical splitters, active optical splitters, and multi-port active optical splitters.

A power supply 114 can be coupled to the light source 116 and controller 112. As described herein, the controller 112 can optionally be configured to control the power supply 114, for example to energize or de-energize the light source 116. Different power supplies 114 can be used in various implementations of the present disclosure. In some implementations, the power supply 114 can include a battery (e.g., a lithium ion battery) and voltage regulator. Additionally, implementations where the field light generator 110 is powered by a battery can be waterproof, allowing for their use in adverse weather conditions and/or wet environments.

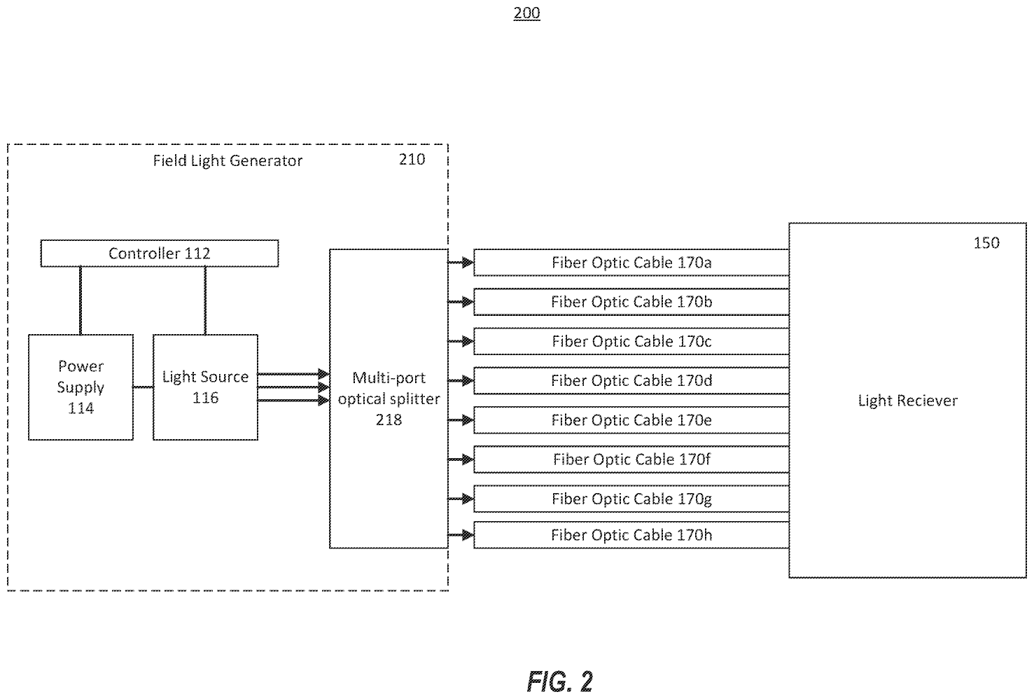

With reference to FIG. 2, implementations of the present disclosure include a field light generator 210 where the optical fiber assembly includes a multi-port optical splitter 218. The multi-port optical splitter 218 can be coupled to multiple fiber optic cables 170a, 170b, 170c, 170d, 170e, 170f, 170g, 170h. While eight fiber optic cables 170a-170h are shown in FIG. 2, it should be understood that implementations of the present disclosure can include multi-port optical splitters 218 with any number of ports and/or combinations of multi-port optical splitters 218. It should also be understood that the field light generator 210 can therefore be coupled to any number of fiber optic cable 170a-170h.

In some implementations of the present disclosure, the system 200 can include multiple field light generators 210, where the multiple field light generators 210 can be coupled in parallel. For example, if there are 10 fiber optic cables, one field light generator 210 can be coupled to some of the ten cables, and another can be coupled to the remaining fiber optic cables. The ten fiber optic cables described herein, and the eight fiber optic cables 170a-170h illustrated in FIG. 2 are intended only as examples, and implementations of the present disclosure can be used in systems with any number of fiber optic cables.

Additionally, while a single light receiver 150 is shown in FIGS. 1-3, any number of light receivers can be used in implementations of the present disclosure. It should be understood that the light receivers 150 described herein can be a light receiver configured to connect to any number of fiber optic cables in various implementations of the present disclosure. Alternatively, any number of light receivers may be attached to separate ends of the fiber cables 170a-h as they are distributed across the communication network.

The multi-port optical splitter 218 can optionally be a passive multi-port optical splitter 218 or an active optical splitter. As used herein, an active optical splitter is a splitter that includes circuitry to split light inputs into multiple outputs at a certain power level. For example, an active optical splitter can take an input signal from a light source 116 and output eight signals of the same power level as the input signal. The active optical splitter can be optionally coupled to the power supply 114 and powered by the power supply.

It should be understood that the systems and methods described herein can be configured to work with both active optical splitters and passive optical splitters. For example, if the splitter is a passive 4-way multi-port optical splitter, then a signal on each of four fiber optic cables coupled to the 4-way multi-port optical splitter would be ¼ of the strength of a signal that was not split by the 4-way multi-port optical splitter. Therefore the light receiver 150 can be configured to expect the splitter loss contribution as well as the loss contributed by the length of the optical fiber and by the splices, if any, as compared to the light source 116. Typical light receivers have expected ranges for received signals. Any receiver capable of detecting light with the expected losses can be used in various implementations of the present disclosure.

As yet another example, in implementations where the optical fiber assembly 118 includes a passive splitter, the light source 116 can optionally be configured to output additional light to compensate partially or completely for the losses caused by an active and/or passive optical splitter. As described herein, implementations of the present disclosure include SFP and other removable light sources 116 that can be switched to allow for different configurations of field light generator 110, 210, depending on whether an active or passive optical splitter is used, and what wavelengths of light are desired by a user.

With reference to FIG. 3, implementations of the present disclosure can be configured to validate a splice 380 between a first fiber optic cable 370a and a second fiber optic cable 370b. As shown in FIG. 3, the splice 380 can be a coupling between a distal end 372b of the first fiber optic cable 370a and a proximal end 374a of the second fiber optic cable 370b. As shown in FIG. 3, the proximal ends 372a, 374a of the cables are the ends of the cables closer to the field light generator 310, and the distal ends 372b, 374b of the first and second fiber optic cables 370a, 370b are the ends further from the field light generator. It should be understood that the system 300 can include any number of fiber optic cables coupled by any number of splices. For example, a third fiber optic cable (not shown) could be joined to the distal end 374b of the second fiber optic cable 370b by a second splice (not shown), a fourth fiber optical cable could be joined to the third fiber optic cable in the same way, and so on.

The splice 380 can include a fault (not shown). A fault in the splice can be any structure or contamination that may cause loss in the transmission of light between the first fiber optic cable 370a and second fiber optic cable 370b. Non-limiting examples of faults include: (A) damaged fibers in either or both of the first fiber optic cable 370a and second fiber optic cable 370b; (B) dirt or other foreign substances in the splice 380; (C) an excessive gap between the first fiber optic cable 370a and second fiber optic cable 370b; and (D) improperly cut fibers at the proximal and/or distal ends of the first fiber optic cable or second fiber optic cable.

The system 300 can be used to detect faults in the splice 380 by comparing the light emitted from the light source 116 to the light received by the light receiver 150. If excessive losses are measured between the light receiver 150 and light source, a fault is likely present in the splice 380.

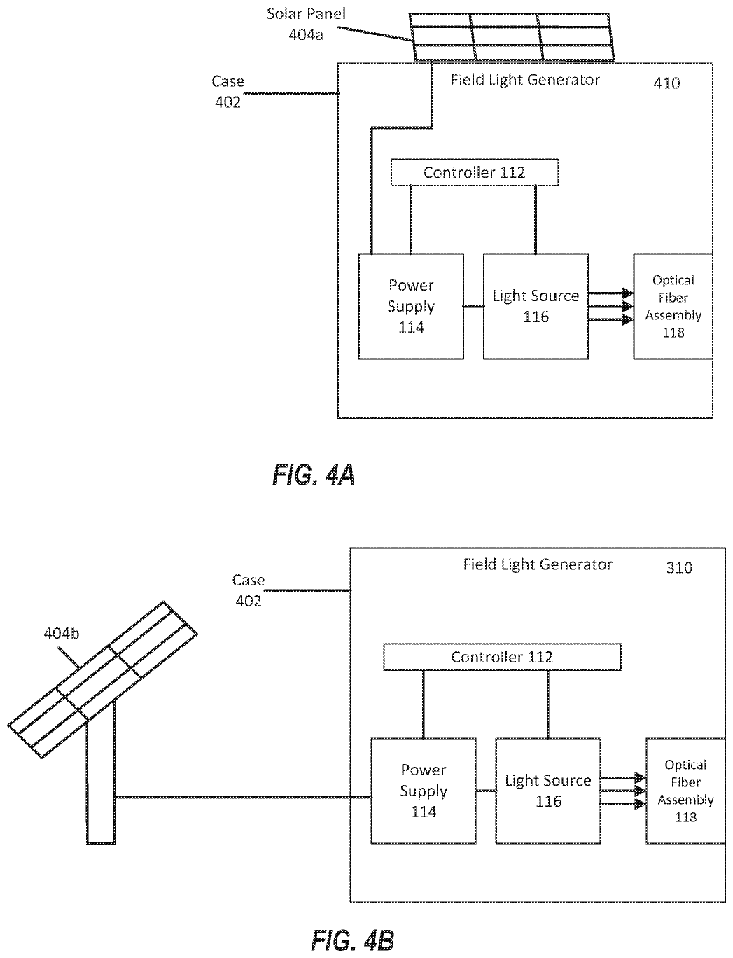

With reference to FIGS. 4A-4B, implementations of the present disclosure can include solar panels and/or waterproof cases. An example case 402 for a light generator 410 is shown in FIG. 4A and FIG. 4B. The case 402 can include any or all of the components of the light generators 110, 210, 310 shown and described with reference to FIGS. 1-3, including the controller 112, power supply 114, light source 116, and optical fiber assembly 118. Optionally, the case 402 can be a weatherized and/or waterproof case configured to seal the components from humidity/moisture in field conditions.

As shown in FIG. 4A, the case 402 can optionally include a solar panel 404a. The solar panel can be operably coupled to the power supply 114. For example, when the power supply 114 includes a battery, the solar panel 404a can be configured to charge the battery.

As shown in FIG. 4B, a solar panel 404b can optionally be deployed at a distance from the case 402. Alternatively, or additionally, the solar panel 404b can be configured to be deployed separate from the case 402 as shown in FIG. 4B. For example, the field light generator 410 in the case 402 shown in FIG. 4B can be positioned inside a structure (not shown), and the solar panel 404b can be positioned outside the structure. This can power the field light generator 410, even when the structure is partially completed or unpowered, so that the field light generator 410 can be used to test the installation of fiber optic equipment or fiber optic cables that are terminated at the structure.

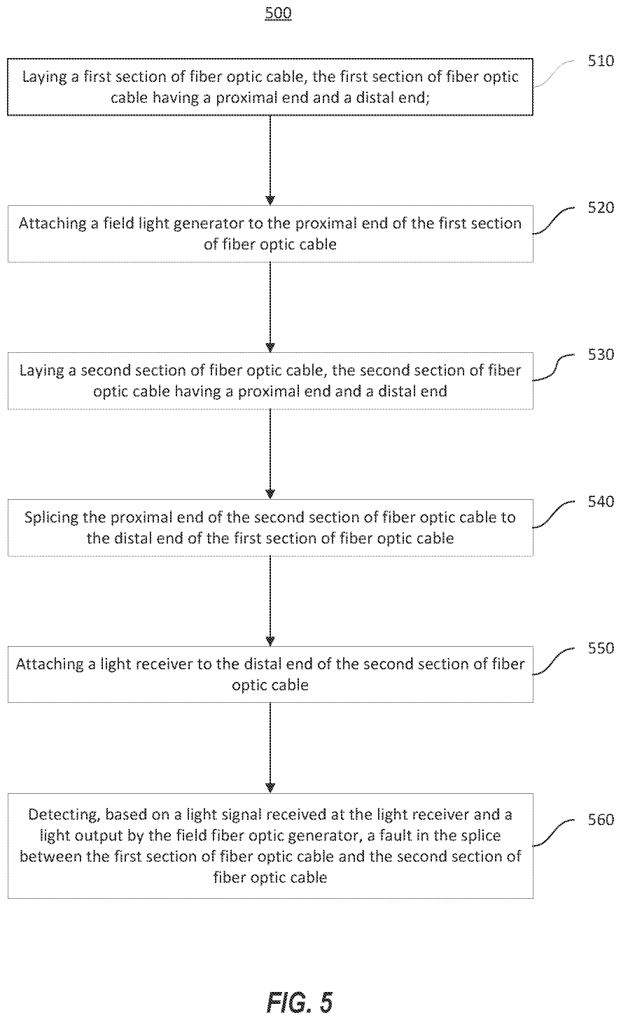

Implementations of the present disclosure include methods for installing fiber optic cables and validating the installation of the fiber optic cables. An example method 500 is shown in FIG. 5.

At step 510, the method includes laying a first section of fiber optic cable (e.g., the first fiber optic cable 370a shown in FIG. 3).

At step 520, the method includes attaching a field light generator (e.g., the field light generator 310 shown in FIG. 3) to the proximal end of the first section of fiber optic cable.

At step 530, the method includes laying a second section of fiber optic cable (e.g., the first fiber optic cable 370b shown in FIG. 3), the second section of fiber optic cable having a proximal end and a distal end.

At step 540, the method includes splicing the proximal end of the second section of fiber optic cable to the distal end of the first section of fiber optic cable (e.g., the splice 380 shown in FIG. 3).

At step 550, the method includes attaching a light receiver (e.g., the light receiver 150 shown in FIG. 3) to the distal end of the second section of fiber optic cable.

At step 560 the method includes detecting, based on a light signal received at the light receiver and a light output by a field light generator (e.g., the field light generator 310 shown in FIG. 3), a fault in the splice between the first section of fiber optic cable and the second section of fiber optic cable.

The method 500 shown in FIG. 5 can improve over conventional methods of validating the installation of a fiber optic cable. In conventional methods, the fiber optic cable may be coupled to a permanent transmitter/receiver/transceiver that is installed to communicate over the fiber optic cable. Then the installation of the fiber optic cable is validated in the conventional method by testing the fiber optic cable using the permanent transmitter/receiver/transceiver. By the time that the permanent transmitter/receiver/transceiver is installed to allow for testing, workers and equipment may be moved to other locations. Therefore implementations of the present disclosure allow for fiber optic cable installers to validate each splice during the construction of a fiber optic system, and to identify faulty splices as they are made, instead of at the end of the project.

Referring to FIG. 6, an example computing device 600 upon which the methods described herein may be implemented is illustrated. It should be understood that the example computing device 600 is only one example of a suitable computing environment upon which the methods described herein may be implemented. Optionally, the computing device 600 can be a well-known computing system including, but not limited to, personal computers, servers, handheld or laptop devices, multiprocessor systems, microprocessor-based systems, network personal computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In its most basic configuration, computing device 600 typically includes at least one processing unit 606 and system memory 604. Depending on the exact configuration and type of computing device, system memory 604 may be volatile (such as random access memory (RAM)), non-volatile (such as read-only memory (ROM), flash memory, etc.), or some combination of the two. This most basic configuration is illustrated in FIG. 3 by dashed line 602. The processing unit 606 may be a standard programmable processor that performs arithmetic and logic operations necessary for operation of the computing device 600. The computing device 600 may also include a bus or other communication mechanism for communicating information among various components of the computing device 600.

Computing device 600 may have additional features/functionality. For example, computing device 600 may include additional storage such as removable storage 608 and non-removable storage 610 including, but not limited to, magnetic or optical disks or tapes. Computing device 600 may also contain network connection(s) 616 that allow the device to communicate with other devices. Computing device 600 may also have input device(s) 614 such as a keyboard, mouse, touch screen, etc. Output device(s) 612 such as a display, speakers, printer, etc. may also be included. The additional devices may be connected to the bus in order to facilitate communication of data among the components of the computing device 600. All these devices are well known in the art and need not be discussed at length here.

The processing unit 606 may be configured to execute program code encoded in tangible, computer-readable media. Tangible, computer-readable media refers to any media that is capable of providing data that causes the computing device 600 (i.e., a machine) to operate in a particular fashion. Various computer-readable media may be utilized to provide instructions to the processing unit 606 for execution. Example tangible, computer-readable media may include, but is not limited to, volatile media, non-volatile media, removable media and non-removable media implemented in any method or technology for storage of information such as computer readable instructions, data structures, program modules or other data. System memory 604, removable storage 608, and non-removable storage 610 are all examples of tangible, computer storage media. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 606 may execute program code stored in the system memory 604. For example, the bus may carry data to the system memory 604, from which the processing unit 606 receives and executes instructions. The data received by the system memory 604 may optionally be stored on the removable storage 608 or the non-removable storage 610 before or after execution by the processing unit 606.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

1. A test system for fiber optic cable installation, the test system comprising:
a light receiver configured to be deployed on a distal end of a fiber optic cable;
a field light generator configured to be deployed on a proximal end of the fiber optic cable, the field light generator comprising:
a power supply;
an optical fiber assembly configured to couple to the proximal end of the fiber optic cable; and
a light source operably coupled to the power supply, wherein the light source is configured to output light through the optical fiber assembly into the proximal end of the fiber optic cable.

2. The test system of claim 1, wherein the test system further comprises a waterproof case configured to house the field light generator.

3. The test system of claim 1, wherein the optical fiber assembly comprises an active optical splitter operably coupled between the light source and the proximal end of the fiber optic cable.

4. The test system of claim 1, wherein the field light generator further comprises a controller operably coupled to the power supply and the light source.

5. The test system of claim 4, wherein the controller further comprises a wireless receiver configured to receive a control signal and wherein the controller is configured to energize or de-energize the light source based on the control signal.

6. The test system of claim 1, wherein the optical fiber assembly comprises a multi-port optical splitter.

7. The test system of claim 1, wherein the light receiver is configured to measure an intensity of light at the distal end of the fiber optic cable.

8. The test system of claim 1, wherein the optical fiber assembly comprises an active splitter operably coupled to the power supply.

9. The test system of claim 1, wherein the light source comprises a small form pluggable (SFP) connector, and an SFP transceiver.

10. The test system of claim 1, wherein the power supply comprises at least one of a solar panel and a battery.

11. The test system of claim 1, wherein the fiber optic cable comprises a first fiber of fiber optic cable and a second fiber of fiber optic cable.

12. A field light generator comprising:
a power supply comprising a battery and power regulation circuitry;
an optical fiber assembly configured to couple to a proximal end of a fiber optic cable; and
a light source operably coupled to the power supply, wherein the light source is configured to output light through the optical fiber assembly into the proximal end of the fiber optic cable.

13. The field light generator of claim 12, further comprising a waterproof case configured to encapsulate the power supply, the optical fiber assembly, and the light source.

14. The field light generator of claim 12, wherein the optical fiber assembly comprises an active optical splitter operably coupled between the light source and the proximal end of the fiber optic cable.

15. The field light generator of claim 12, wherein the optical fiber assembly comprises a passive optical splitter operably coupled between the light source and the proximal end of the fiber optic cable.

16. The field light generator of claim 12, wherein the field light generator further comprises a controller operably coupled to the power supply and the light source.

17. The field light generator of claim 16, wherein the controller further comprises a wireless receiver configured to receive a control signal and wherein the controller is configured to energize or de-energize the light source based on the control signal.

18. The field light generator of claim 16, wherein the light source comprises a frequency selectable light source operably coupled to the controller and wherein the controller can select the frequency of the light output from the light source.

19. The field light generator of claim 12, wherein the optical fiber assembly comprises a multi-port optical splitter.

20. A method of validating a fiber optic installation without a field router, the method comprising:
laying a first section of fiber optic cable, the first section of fiber optic cable having a proximal end and a distal end;
attaching a field light generator to the proximal end of the first section of fiber optic cable;
laying a second section of fiber optic cable, the second section of fiber optic cable having a proximal end and a distal end;
splicing the proximal end of the second section of fiber optic cable to the distal end of the first section of fiber optic cable;
attaching a light receiver to the distal end of the second section of fiber optic cable; and
detecting, based on a light signal received at the light receiver and a light output by the field light generator, a fault in the splice between the first section of fiber optic cable and the second section of fiber optic cable.
